(19) United States
(12) Patent Application Publication
(10) Pub. No.: US 2018/0345730 A1
(43) Pub. Date: Dec. 6, 2018

(54) Pneumatic Tire

(71) Applicants: The Yokohama Rubber Co., LTD., Minato-ku, Tokyo (JP); Kumho Tire Co., Inc., Gwangsan-gu, Gwangju (KR)

(72) Inventors: Hiroshi HATA, Hiratsuka-shi, Kanagawa (JP); Jun MATSUDA, Hiratsuka-shi, Kanagawa (JP); Kee Woon KIM, Gwangsan-gu, Gwangju (KR); Chang Jung PARK, Gwangsan-gu, Gwangju (KR)

(21) Appl. No.: 15/779,048

(22) PCT Filed: Nov. 25, 2015
(86) PCT No.: PCT/JP2015/083120

§ 371 Date: May 24, 2018

(51) Int. Cl. B60C 11/01; B60C 13/02; B60C 19/00

(52) U.S. Cl. CPC B60C 11/01; B60C 19/002; B60C 13/02

(57) ABSTRACT

A pneumatic tire includes a lug groove disposed outermost in a tire lateral direction in a tread portion, the lug groove opening outward in the tire lateral direction; a projection portion disposed outward of an opening portion of the lug groove in the tire lateral direction, the projection portion extending outward in a tire radial direction past a groove bottom of the lug groove at maximum groove depth and including an end disposed inward of a road contact surface of the tread portion in the tire radial direction, when the pneumatic tire is mounted on a regular rim, inflated to a regular internal pressure, and loaded with 70% of a regular load; and a reinforcing portion disposed at least at a base end of the projection portion, the reinforcing portion having a JIS-A rubber hardness greater than that of a rubber material around the projection portion.

### TECHNICAL FIELD

The present technology relates to a pneumatic tire that reduces external noise.

### BACKGROUND ART

In the related art, pneumatic tires designed to reduce vehicle external noise are known. For example, the pneumatic tire described in Japanese Patent Publication No. 2012-096776 includes a lug groove that opens outward in a tire lateral direction on an outermost side of a tread portion in the tire lateral direction, and a projection portion disposed outward of the opening portion of the lug groove in the tire lateral direction. According to this pneumatic tire, by the projection portion being located outward of the opening portion of the lug groove in the tire lateral direction, when a vehicle on which the pneumatic tire is mounted travels, the sound produced by air column resonance is prevented from being released outward from the lug groove in the tire lateral direction. As a result, vehicle external noise can be reduced.

In another example, the pneumatic tire described in Japanese Patent Publication No. 2012-006483 includes a projection portion on an outer surface of a buttress portion, the projection portion projecting outward in a tire radial direction and continuously extending in a tire circumferential direction.

In another example, the pneumatic tire described in Japanese Patent Publication No. 2012-066662 includes a projection portion for reducing spray disposed on a side wall portion. The projection portion includes a soft rubber layer of less than 55 degrees and with a Japanese Industrial Standards (JIS) A rubber hardness less than that of the tread rubber.

As described above, Japanese Patent Publication Nos. 2012-096776 and 2012-006483 describe a projection portion blocking sound from being released outward in the tire lateral direction. However, when the pneumatic tire rolls, the pneumatic tire deforms as it comes into contact with the ground, causing the projection portion to deform and becoming a vibration source itself, generating vehicle external noise. Thus, the vehicle exterior noise reduction effect may be reduced or a vehicle exterior noise reduction effect may be unable to be obtained.

### SUMMARY

The present technology provides a pneumatic tire that can ensure a vehicle external noise reduction effect.

A pneumatic tire according to an embodiment of the present technology includes:

a lug groove disposed outermost in a tire lateral direction in a tread portion, the lug groove opening outward in the tire lateral direction;

a projection portion disposed outward of an opening portion of the lug groove in the tire lateral direction, the projection portion extending outward in a tire radial direction past a groove bottom of the lug groove at maximum groove depth in a meridian cross-section and including an end disposed inward of a road contact surface of the tread portion in the tire radial direction, when the pneumatic tire is mounted on a regular rim, inflated to a regular internal pressure, and loaded with 70% of a regular load; and

a reinforcing portion disposed at least at a base end of the projection portion, the reinforcing portion having a JIS-A rubber hardness greater than a JIS-A rubber hardness of a rubber material around the projection portion.

According to the pneumatic tire, by providing the reinforcing portion with a JIS-A rubber hardness greater than that of the rubber material around the projection portion at least at the base end of the projection portion, the deformation of the projection portion is suppressed. As a result, generation of noise caused by vibration of the projection portion can be suppressed, and the intrinsic noise shielding effect of the projection portion can be obtained. Thus, the vehicle exterior noise reduction effect can be ensured.

In a pneumatic tire according to an embodiment of the present technology, the reinforcing portion has a height h ranging from 60% to 100% of an extension height H of the projection portion in a meridian cross-section.

According to the pneumatic tire, by the height h of the reinforcing portion ranging from 60% to 100% of the extension height H of the projection portion, the deformation of the projection portion is suppressed, and an effect of suppressing vibration caused by the projection portion deforming can be significantly obtained. When the height h of the reinforcing portion is less than 60% of the extension height H of the projection portion, the effect of suppressing the deformation of the projection portion is reduced.

In a pneumatic tire according to an embodiment of the present technology, the reinforcing portion has a thickness t ranging from 50% to 100% of a thickness T of the projection portion in a meridian cross-section.

According to the pneumatic tire, by the thickness t of the reinforcing portion ranging from 50% to 100% of the thickness T of the projection portion, the deformation of the projection portion is suppressed, and an effect of suppressing vibration caused by the projection portion deforming can be significantly obtained. When the thickness t of the reinforcing portion is less than 50% of the thickness T of the projection portion, the effect of suppressing the deformation of the projection portion is reduced.

In a pneumatic tire according to an embodiment of the present technology, the reinforcing portion has a JIS-A rubber hardness of 3 points or greater than a JIS-A rubber hardness of a rubber material around the projection portion with a greatest JIS-A rubber hardness.

According to the pneumatic tire, by the JIS-A rubber hardness of the reinforcing portion being 3 points greater than that of the rubber member around the projection portion with the greatest JIS-A rubber hardness, the deformation of the projection portion is suppressed, and an effect of suppressing vibration caused by the projection portion deforming can be significantly obtained.

In a pneumatic tire according to an embodiment of the present technology, a recess/protrusion is formed on an inner surface of the protrusion portion in the tire lateral direction.

According to the pneumatic tire, by the recess/protrusion being formed on the inner surface of the projection portion in the tire lateral direction, the surface area of the inner surface of the projection portion in the tire lateral direction is increased. This increases the surface area for shielding the air column resonance and allows the noise shielding effect to be significantly obtained.

In a pneumatic tire according to an embodiment of the present technology, the projection portion has a distance in the tire radial direction from the road contact surface of the tread portion to the end of 0.5 mm or greater in a meridian cross-section, when the pneumatic tire is mounted on a regular rim, inflated to a regular internal pressure, and loaded with 70% of a regular load.

In a case where the distance in the tire radial direction between the road contact surface of the tread portion and the end being less than 0.5 mm, when the pneumatic tire deforms when the vehicle travels, the frequency of the projection portion coming into contact with the road surface and the like is likely to increase, increasing instances of the projection portion deforming. Thus, according to the pneumatic tire, by the distance in the tire radial direction between the road contact surface of the tread portion and the end being 0.5 mm to greater, the instances of the projection portion deforming are reduced. This allows a vehicle exterior noise reduction effect to be ensured.

In a pneumatic tire according to an embodiment of the present technology, the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

When the angle formed by the center straight line and the tire radial direction line is greater than 15° inward in the tire lateral direction, the projection portion is susceptible to coming into contact with the tire itself, which may cause wear and chipping in the portion where contact occurs. When the angle formed by the center straight line and the tire radial direction line is greater than 45° outward in the tire lateral direction, the projection portion is disposed away from the lug groove, and a noise shielding effect is difficult to obtain. Thus, according to the pneumatic tire, by the angle formed by the center straight line and the tire radial direction line ranging from 15° inward in the tire lateral direction to 45° outward in the tire lateral direction (from −15° to +45°, where inward in the tire lateral direction is minus and outward in the tire lateral direction is plus), a noise shielding effect from the projection portion can be significantly obtained.

In a pneumatic tire according to an embodiment of the present technology, a vehicle inner/outer side orientation when the pneumatic tire is mounted on a vehicle is designated, and the projection portion is at least formed on a vehicle outer side.

According to the pneumatic tire, vehicle external noise is released on the vehicle outer side. Thus, by forming the projection portion on at least the vehicle outer side, noise shielding can be effectively provided, and vehicle external noise can be reduced.

A pneumatic tire according to an embodiment of the present technology can ensure a vehicle exterior noise reduction effect.

### BRIEF DESCRIPTION OF DRAWINGS

FIG. 1 is a meridian cross-sectional view of a pneumatic tire according to an embodiment of the present technology.

FIG. 2 is a meridian cross-sectional view of a pneumatic tire according to an embodiment of the present technology.

FIG. 3 is an enlarged view of a main portion of the pneumatic tire illustrated in FIGS. 1 and 2.

FIG. 4 is an enlarged view of a main portion of the pneumatic tire illustrated in FIGS. 1 and 2.

FIG. 5 is a side view of a projection portion as viewed from inward in the tire lateral direction.

FIG. 6 is a side view of a projection portion as viewed from inward in the tire lateral direction.

FIG. 7 is a side view of a projection portion as viewed from inward in the tire lateral direction.

FIG. 8 is a side view of a projection portion as viewed from inward in the tire lateral direction.

FIG. 9 is a side view of a projection portion as viewed from inward in the tire lateral direction.

FIG. 10 is an enlarged cross-sectional view of a main portion of another example of a pneumatic tire according to an embodiment of the present technology.

FIG. 11 is a partial perspective view of the example of the pneumatic tire illustrated in FIG. 10.

FIG. 12 is a table showing the results of performance tests of pneumatic tires according to examples of the present technology.

FIG. 13 is a table showing the results of performance tests of pneumatic tires according to examples of the present technology.

### DETAILED DESCRIPTION

Embodiments of the present technology are described in detail below with reference to the drawings. However, the present technology is not limited by the embodiments. Constituents of the embodiments include elements that can be easily replaced by those skilled in the art and elements substantially the same as the constituents of the embodiments. Furthermore, the modified examples described in the embodiments can be combined as desired within the scope apparent to those skilled in the art.

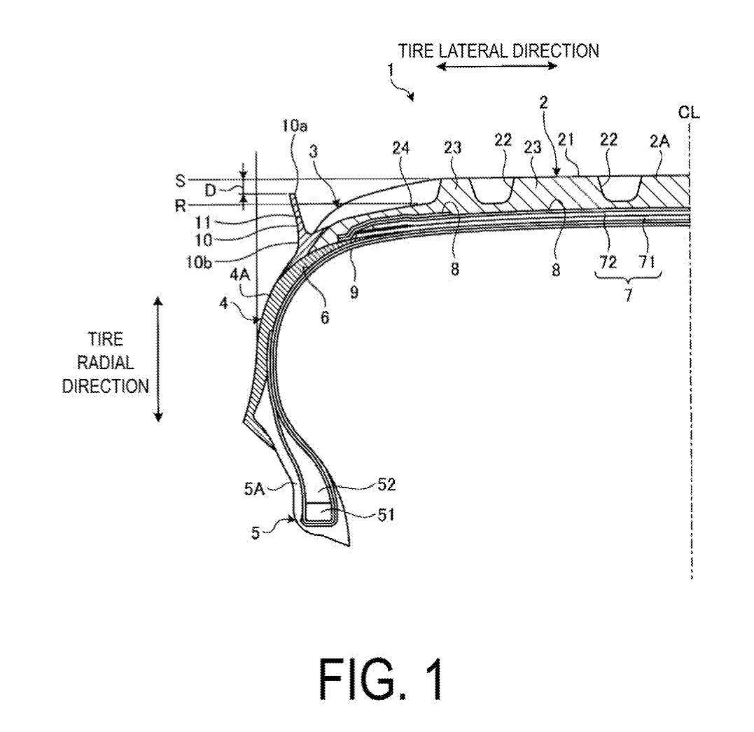

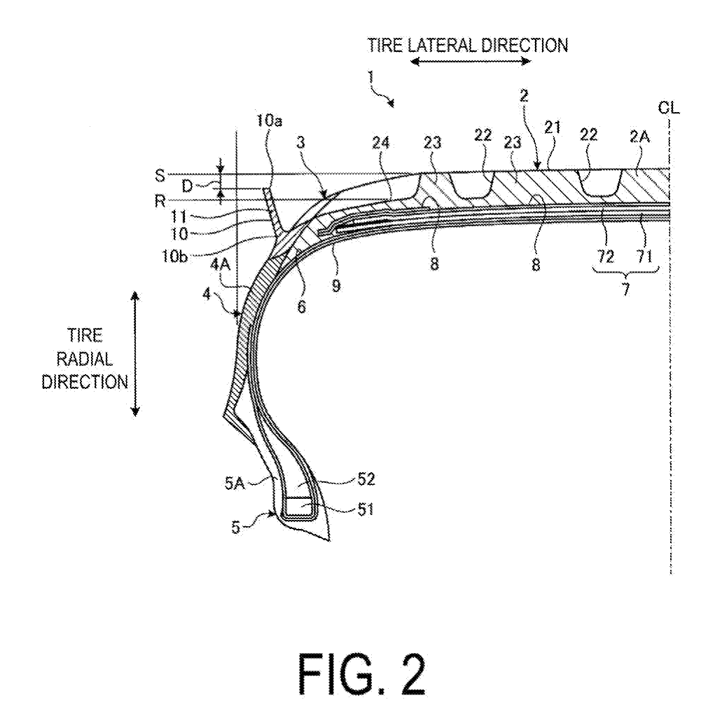

FIGS. 1 and 2 are meridian cross-sectional views of a pneumatic tire according to the present embodiment.

Herein, “tire radial direction” refers to the direction orthogonal to the rotation axis (not illustrated) of a pneumatic tire 1. “Inward in the tire radial direction” refers to the direction toward the rotation axis in the tire radial direction. “Outward in the tire radial direction” refers to the direction away from the rotation axis in the tire radial direction. “Tire circumferential direction” refers to the circumferential direction with the rotation axis as the center axis. Additionally, “tire lateral direction” refers to the direction parallel with the rotation axis. “Inward in the tire lateral direction” refers to the direction toward a tire equatorial plane CL (tire equator line) in the tire lateral direction. “Outward in the tire lateral direction” refers to the direction away from the tire equatorial plane CL in the tire lateral direction. “Tire equatorial plane CL” refers to the plane orthogonal to the rotation axis of the pneumatic tire 1 that passes through the center of the tire width of the pneumatic tire 1. “Tire width” is the width in the tire lateral direction between components located outward in the tire lateral direction, or in other words, the distance between the components that are the most distant from the tire equatorial plane CL in the tire lateral direction. “Tire equator line” refers to the line along the tire circumferential direction of the pneumatic tire 1 that lies on the tire equatorial plane CL. In the present embodiment, the tire equator line and the tire equatorial plane are denoted by the same reference sign CL. In addition, the pneumatic tire 1 described below has a configuration which is essentially symmetrical about the tire equatorial plane CL. Thus, for the sake of description, the pneumatic tire 1 is illustrated in a meridian cross-sectional view (FIGS. 1 and 2) and described in reference to the configuration on only one side (the left side in FIGS. 1 and 2) of the tire equatorial plane CL. A description of the other side (right side in FIGS. 1 and 2) is omitted.

As illustrated in FIGS. 1 and 2, the pneumatic tire 1 of the present embodiment includes a tread portion 2, shoulder portions 3 on opposite sides of the tread portion 2, and sidewall portions 4 and bead portions 5 continuing in that order from the shoulder portions 3. The pneumatic tire 1 also includes a carcass layer 6, a belt layer 7, a belt reinforcing layer 8, and an innerliner layer 9.

The tread portion 2 is made of tread rubber 2A, is exposed on the outermost side of the pneumatic tire 1 in the tire radial direction, and the surface thereof constitutes the contour of the pneumatic tire 1. A tread surface 21 is formed on the outer circumferential surface of the tread portion 2, in other words, on the road contact surface that comes into contact with the road surface when running. The tread surface 21 is provided with a plurality (four in the present embodiment) of main grooves 22 that are straight main grooves extending in the tire circumferential direction parallel with the tire equator line CL. Moreover, a plurality of rib-like land portions 23 that extend in the tire circumferential direction are formed in the tread surface 21 by the plurality of main grooves 22. Note that the main grooves 22 may extend in the tire circumferential direction in a bending or curving manner. Additionally, lug grooves 24 that extend in a direction that intersects the main grooves 22 are provided in the land portions 23 of the tread surface 21. In the present embodiment, the lug grooves 24 show in the outermost land portions 23 in the tire lateral direction. The lug grooves 24 may meet the main grooves 22. Alternatively, the lug grooves 24 may have at least one end that does not meet the main grooves 22 and terminates within a land portion 23. In an embodiment in which both ends of the lug grooves 24 meet the main grooves 22, the land portions 23 are formed into a plurality of block-like land portions divided in the tire circumferential direction. Note that the lug grooves 24 may extend inclined with respect to the tire circumferential direction in a bending or curving manner.

The shoulder portions 3 are portions of the tread portion 2 located outward in the tire lateral direction on both sides. In other words, the shoulder portions 3 are made of the tread rubber 2A. Additionally, the sidewall portions 4 are exposed on the outermost sides of the pneumatic tire 1 in the tire lateral direction. The sidewall portions 4 are each made of a side rubber 4A. As illustrated in FIG. 1, an outer end portion of the side rubber 4A in the tire radial direction is disposed inward of an end portion of the tread rubber 2A in the tire radial direction. An inner end portion of the side rubber 4A in the tire radial direction is disposed outward of an end portion of a rim cushion rubber 5A described below in the tire lateral direction. Additionally, as illustrated in FIG. 2, the outer end portion of the side rubber 4A in the tire radial direction may be disposed outward of the end portion of the tread rubber 2A in the tire radial direction. The bead portions 5 each include a bead core 51 and a bead filler 52. The bead core 51 is formed by winding a bead wire, which is a steel wire, into an annular shape. The bead filler 52 is a rubber material that is disposed in the space formed by an end of the carcass layer 6 in the tire lateral direction folded back at the position of the bead core 51. The bead portions 5 each include an outwardly exposed rim cushion rubber 5A that comes into contact with the rim (not illustrated). The rim cushion rubber 5A extends from the tire inner side of the bead portion 5 around the lower end portion thereof to a position (sidewall portion 4) covering the bead filler 52 on the tire outer side.

The end portions of the carcass layer 6 in the tire lateral direction are folded back around the pair of bead cores 51 from inward to outward in the tire lateral direction, and the carcass layer 6 is stretched in a toroidal shape in the tire circumferential direction to form the framework of the tire. Note that the carcass layer 6 has a configuration that is mainly continuous in a radial direction, but may include a divided portion on the inner side of the tread portion 2 in the tire radial direction. The carcass layer 6 is constituted by a plurality of coating-rubber-covered carcass cords (not illustrated) disposed in alignment at an angle with respect to the tire circumferential direction that conforms with the tire meridian direction. The carcass layer 6 is provided with at least one layer.

The belt layer 7 has a multilayer structure in which at least two belts 71, 72 are layered. In the tread portion 2, the belt layer 7 is disposed outward of the carcass layer 6 in the tire radial direction, i.e. on the outer circumference thereof, and covers the carcass layer 6 in the tire circumferential direction. The belts 71 and 72 each include a plurality of coating-rubber-covered cords (not illustrated) disposed in alignment at a predetermined angle with respect to the tire circumferential direction (for example, from 20 degrees to 30 degrees). Moreover, the belts 71 and 72 overlap each other and are disposed so that the direction of the cords of the respective belts intersect each other.

The belt reinforcing layer 8 may be provided for support as necessary. The belt reinforcing layer 8 is disposed outward of the belt layer 7 in the tire radial direction, i.e. on the outer circumference thereof, and covers the belt layer 7 in the tire circumferential direction. The belt reinforcing layer 8 includes a plurality of coating-rubber-covered cords (not illustrated) disposed in alignment in the tire lateral direction substantially parallel (±5 degrees) with the tire circumferential direction. The belt reinforcing layer 8 illustrated in FIGS. 1 and 2 is disposed so as to cover the entire belt layer 7 and disposed in a layered manner so as to cover end portions of the belt layer 7 in the tire lateral direction. The configuration of the belt reinforcing layer 8 is not limited to that described above. While not illustrated in the drawings, a configuration may be used in which, for example, two layers are disposed so as to cover all of the belt layer 7 or to cover only the end portions of the belt layer 7 in the tire lateral direction. Additionally, while not illustrated in the drawings, a configuration of the belt reinforcing layer 8 may be used in which, for example, one layer is disposed so as to cover all of the belt layer 7 or to cover only the end portions of the belt layer 7 in the tire lateral direction. In other words, the belt reinforcing layer 8 overlaps with at least the end portions of the belt layer 7 in the tire lateral direction. Additionally, the belt reinforcing layer 8 is constituted of a band-like strip material (having, for example, a width of 10 mm) wound in the tire circumferential direction.

The innerliner layer 9 is the tire inner surface, i.e. the inner circumferential surface of the carcass layer 6, and reaches the lower portion of the bead cores 51 of the pair of bead portions 5 at both end portions in the tire lateral direction and extends in the tire circumferential direction in a toroidal shape. The innerliner layer 9 prevents air molecules from escaping from the tire.

The pneumatic tire 1 described above is provided with a projection portion 10 on the shoulder portion 3. The projection portion 10 is provided continuously in the tire circumferential direction and is disposed outward in the tire lateral direction of the opening portion of the outermost lug groove 24 in the tire lateral direction provided on the tread portion 2. The projection portion 10 is formed projecting outward in the tire radial direction. Additionally, the projection portion 10, in a meridian cross-section, extends outward in the tire radial direction of a groove bottom R with the maximum groove depth of the outermost lug groove 24 in the tire lateral direction, and an end 10a of the projection portion 10 is disposed inward in the tire radial direction of the road contact surface S of the tread portion 2, when the pneumatic tire 1 is mounted on a regular rim, inflated to the regular internal pressure, and loaded with 70% of the regular load. Note that a portion of the lug groove 24 may run into the inner surface in the tire lateral direction of the projection portion 10.

Here, “regular rim” refers to a “standard rim” defined by the Japan Automobile Tyre Manufacturers Association Inc. (JATMA), a “Design rim” defined by the Tire and Rim Association, Inc. (TRA), or a “Measuring rim” defined by the European Tyre and Rim Technical Organisation (ETRTO). “Regular internal pressure” refers to “maximum air pressure” defined by JATMA, a maximum value given in “TIRE LOAD LIMITS AT VARIOUS COLD INFLATION PRESSURES” defined by TRA, or “INFLATION PRESSURES” defined by ETRTO. “Regular load” refers a “maximum load capacity” defined by JATMA, the maximum value given in “TIRE LOAD LIMITS AT VARIOUS COLD INFLATION PRESSURES” defined by TRA, and a “LOAD CAPACITY” defined by ETRTO.

The road contact surface S is the surface where the tread surface 21 of the pneumatic tire 1 comes into contact with the road surface, when the pneumatic tire 1 is mounted on a regular rim, inflated to the regular internal pressure, and loaded with 70% of the regular load.

In other words, according to this pneumatic tire 1, by the projection portion 10 being located outward of the opening portion of the lug groove 24 in the tire lateral direction, when a vehicle on which the pneumatic tire 1 is mounted travels, the sound produced by air column resonance is shielded and prevented from being released outward from the lug groove 24 in the tire lateral direction. As a result, vehicle external noise can be reduced.

In the pneumatic tire of the present embodiment, the projection portion 10 includes a reinforcing portion 11 with a JIS-A rubber hardness which is greater than that of the rubber material around the projection portion 10. In the pneumatic tire 1 illustrated in FIGS. 1 and 2, the projection portion 10 is entirely composed of the reinforcing portion 11. The rubber material around the projection portion 10 includes the tread rubber 2A of the tread portion 2 and the side rubber 4A of the sidewall portion 4 described above. In the pneumatic tire 1 illustrated in FIG. 1, an outer end portion of the side rubber 4A in the tire radial direction is disposed inward of an end portion of the tread rubber 2A in the tire radial direction, and the reinforcing portion 11 composing the projection portion 10 is disposed outward of the side rubber 4A in the tire radial direction and at the outer end portion of the tread rubber 2A in the tire lateral direction. In the pneumatic tire 1 illustrated in FIG. 2, an outer end portion of the side rubber 4A in the tire radial direction is disposed outward of an end portion of the tread rubber 2A in the tire radial direction, and the reinforcing portion 11 composing the projection portion 10 is disposed outward of the tread rubber 2A in the tire radial direction and at the outer end portion of the side rubber 4A in the tire radial direction.

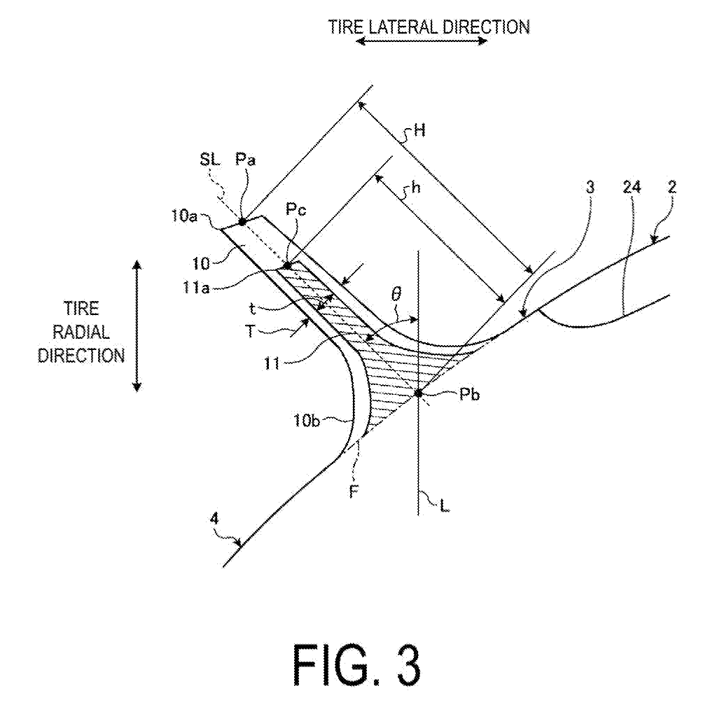

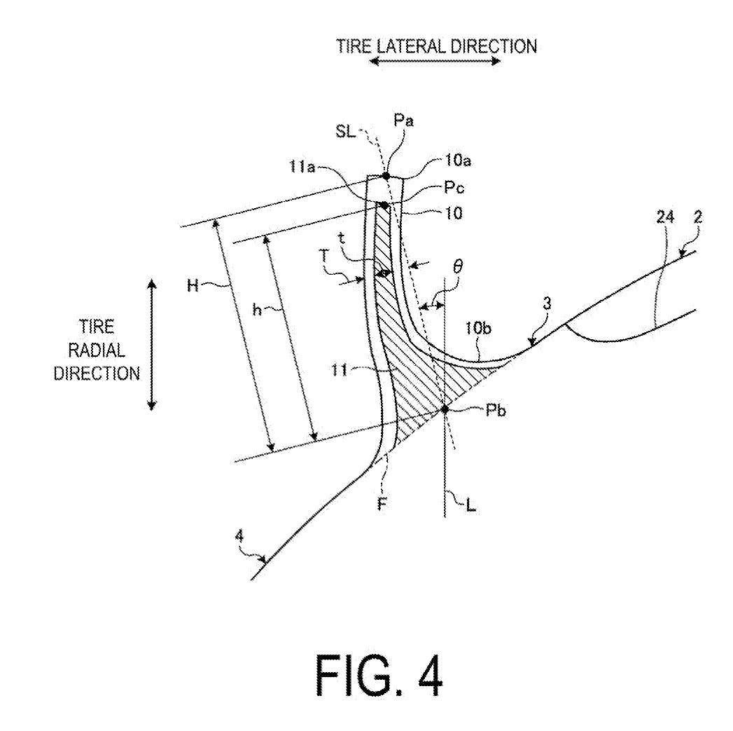

As illustrated in FIGS. 1 and 2, the reinforcing portion 11 may compose the entire projection portion 10 or may partially compose the projection portion 10. FIGS. 3 and 4 are enlarged views of a main portion of the pneumatic tire illustrated in FIGS. 1 and 2, with the projection portion 10 enlarged. In FIGS. 3 and 4, the reinforcing portion 11 is only illustrated located outward of an imaginary profile F of the shoulder portion 3 between the tread portion 2 and the sidewall portion 4. The reinforcing portion 11 composes the portion of the projection portion 10 outward of the imaginary profile F. Note that the base portion of the projection portion 10 projecting outward from the imaginary profile F is defined as a base end 10b of the projection portion 10. The reinforcing portion 11 illustrated in FIGS. 3 and 4 extends inside the projection portion 10 from the base end 10b of the projection portion 10 toward the end 10a and ends partway up the projection portion 10. In this way, the reinforcing portion 11 is at least provided in the base end 10b of the projection portion 10.

Note that the projection portion 10 illustrated in FIGS. 3 and 4 includes the reinforcing portion 11 extending internally therethrough and a member other than the reinforcing portion 11 formed around the reinforcing portion 11 and covering it. In such an embodiment, the member other than the reinforcing portion 11 forming the outer circumference of the projection portion 10 may be made of the same rubber material as the tread rubber 2A and the side rubber 4A. For example, as illustrated in FIG. 1, in an embodiment in which the side rubber 4A is disposed inward of the tread rubber 2A in the tire radial direction, the tread rubber 2A may be the member other than the reinforcing portion 11 that forms the outer circumference of the projection portion 10. As illustrated in FIG. 2, in an embodiment in which the side rubber 4A is disposed outward of the tread rubber 2A in the tire radial direction, the side rubber 4A may be the member other than the reinforcing portion 11 that forms the outer circumference of the projection portion 10. Note that the reinforcing portion 11 may compose the entire base end 10b of the projection portion 10, and a member other than the reinforcing portion 11 extending from the base end 10b may compose a portion of the projection portion 10 closer to the end 10a.

As described above, the reinforcing portion 11 is a member with a JIS-A rubber hardness greater than that of the tread rubber 2A and the side rubber 4A. Specifically, this member may be a single rubber material, a rubber material including a reinforcing member such as a cord, a thermoplastic elastomer, a thermoplastic resin, and the like.

In this way, the pneumatic tire 1 of the present embodiment includes:

a lug groove 24 disposed outermost in a tire lateral direction in a tread portion 2, the lug groove 24 opening outward in the tire lateral direction;

a projection portion 10 disposed outward of an opening portion of the lug groove 24 in the tire lateral direction, the projection portion 10 extending outward in a tire radial direction past a groove bottom R of the lug groove 24 at maximum groove depth in a meridian cross-section and including an end 10a disposed inward of a road contact surface S of the tread portion 2 in the tire radial direction, when the pneumatic tire 1 is mounted on a regular rim, inflated to a regular internal pressure, and loaded with 70% of a regular load; and

a reinforcing portion 11 disposed at least at a base end 10b of the projection portion 10, the reinforcing portion 11 having a JIS-A rubber hardness greater than that of a rubber material around the projection portion 10.

According to the pneumatic tire 1, by providing the reinforcing portion 11 with a JIS-A rubber hardness greater than that of the rubber material around the projection portion 10 (the tread rubber 2A and the side rubber 4A) at least at the base end 10b of the projection portion 10, the deformation of the projection portion 10 is suppressed. As a result, generation of noise caused by vibration of the projection portion 10 can be suppressed, and the intrinsic noise shielding effect of the projection portion 10 can be obtained. Thus, the vehicle exterior noise reduction effect can be ensured.

As illustrated in FIGS. 3 and 4, in the pneumatic tire 1 of the present embodiment, the reinforcing portion 11 preferably has a height h ranging from 60% to 100% of an extension height H of the projection portion 10, in a meridian cross-section.

As illustrated in FIGS. 3 and 4, the extension height H of the projection portion 10 is the length of a center straight line SL that joins a center point Pa of the thickness of the end 10a of the projection portion 10 and a center point Pb of the thickness (imaginary profile F) of the base end 10b, in a meridian cross-section. As illustrated in FIGS. 3 and 4, the height h of the reinforcing portion 11 is the length projected on the center straight line SL by the dimensions from the center point Pb of the thickness of the base end 10b of the projection portion 10 to a center point Pc of the thickness of an end 11a. In FIG. 3, the center point Pc of the thickness of the end 11a of the reinforcing portion 11 is located on the center straight line SL.

According to the pneumatic tire 1, by the height h of the reinforcing portion 11 ranging from 60% to 100% of the extension height H of the projection portion 10, the deformation of the projection portion 10 is suppressed, and an effect of suppressing vibration caused by the projection portion 10 deforming can be significantly obtained. When the extension height h of the reinforcing portion 11 is less than 60% of the extension height H of the projection portion 10, the effect of suppressing the deformation of the projection portion 10 is reduced. Note that to significantly obtain an effect of suppressing vibration caused by the projection portion 10 deforming, the height h of the reinforcing portion 11 is preferably 70% or greater than the extension height H of the projection portion 10, and more preferably 80% or greater. In other words, the height h of the reinforcing portion 11 is more preferably close to 100% of the extension height H of the projection portion 10.

As illustrated in FIGS. 3 and 4, in the pneumatic tire 1 of the present embodiment, the reinforcing portion 11 preferably has a thickness t ranging from 50% to 100% of a thickness T of the projection portion 10, in a meridian cross-section.

As illustrated in FIGS. 3 and 4, the thickness T of the projection portion 10 and the thickness t of the reinforcing portion 11, in a meridian cross-section, are dimensions on a line orthogonal to the center straight line SL used as a reference for the height H, h. Note that by thickness T of the projection portion 10 at a position 50% of the height H ranging from 1 mm to 15 mm, the intrinsic noise shielding effect of the projection portion 10 can be sufficiently obtained.

According to the pneumatic tire 1, by the thickness t of the reinforcing portion 11 ranging from 50% to 100% of the thickness T of the projection portion 10, the deformation of the projection portion 10 is suppressed, and an effect of suppressing vibration caused by the projection portion 10 deforming can be significantly obtained. When the thickness t of the reinforcing portion 11 is less than 50% of the thickness T of the projection portion 10, the effect of suppressing the deformation of the projection portion 10 is reduced. Note that to significantly obtain an effect of suppressing vibration caused by the projection portion 10 deforming, the thickness t of the reinforcing portion 11 is preferably 60% or greater than the thickness T of the projection portion 10, and more preferably 70% or greater. In other words, the thickness t of the reinforcing portion 11 is more preferably close to 100% of the thickness T of the projection portion 10.

In the pneumatic tire 1 of the present embodiment, the reinforcing portion 11 preferably has a JIS-A rubber hardness of 3 points or greater than that of the rubber material around the projection portion 10 (the tread rubber 2A and the side rubber 4A) with the greatest JIS-A rubber hardness.

According to the pneumatic tire 1, by the JIS-A rubber hardness of the reinforcing portion 11 being 3 points greater than that of the member with the greatest JIS-A rubber hardness out of the tread rubber 2A or the side rubber 4A, the deformation of the projection portion 10 is suppressed, and an effect of suppressing vibration caused by the projection portion 10 deforming can be significantly obtained. Note that to significantly obtained an effect of suppressing the vibration caused by the projection portion 10 deforming, the JIS-A rubber hardness of the reinforcing portion 11 is preferably 5 points or greater than the rubber material around the reinforcing portion 11 (the tread rubber 2A and the side rubber 4A) with the greatest JIS-A rubber hardness.

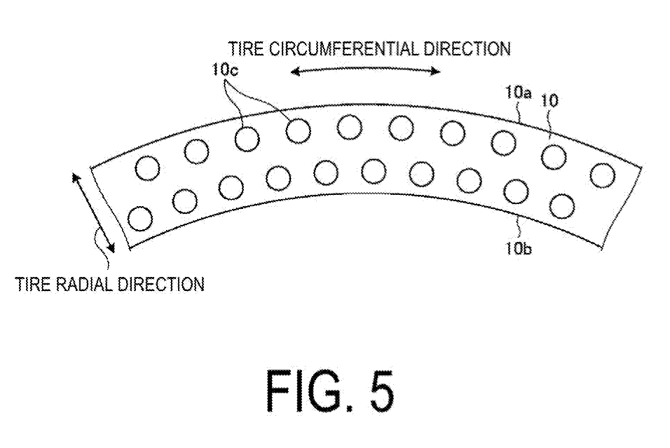

FIGS. 5 to 9 are side views of a projection portion as viewed from inward in the tire lateral direction. As illustrated in FIGS. 5 to 9, in the pneumatic tire 1 of the present embodiment, the projection portion 10 preferably includes a recess/protrusion 10c formed on the inner surface of the projection portion 10 in the tire lateral direction.

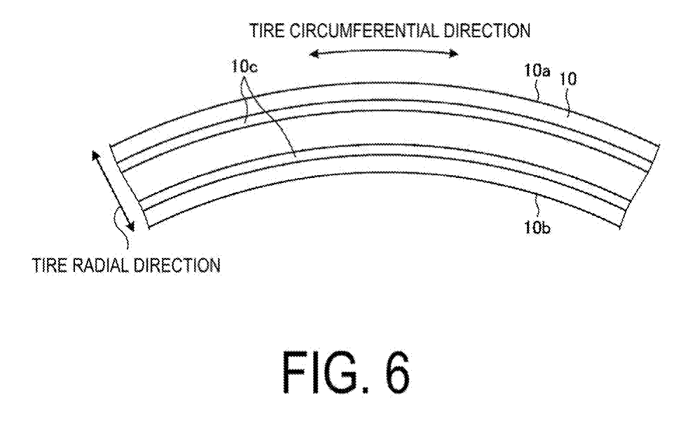

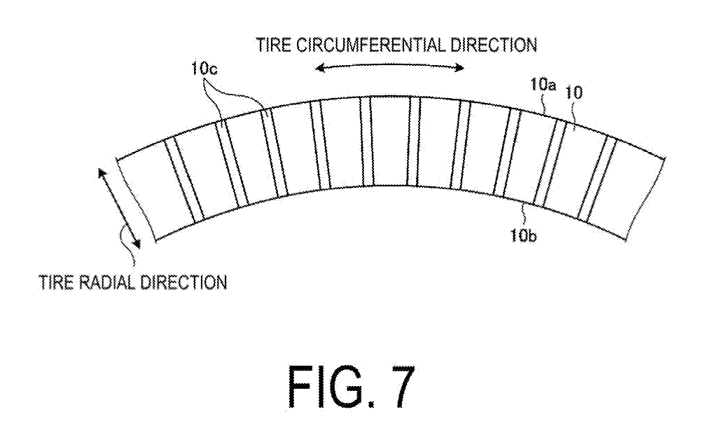

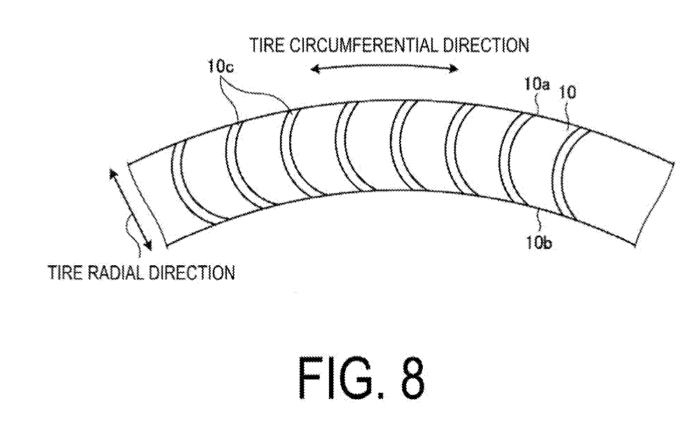

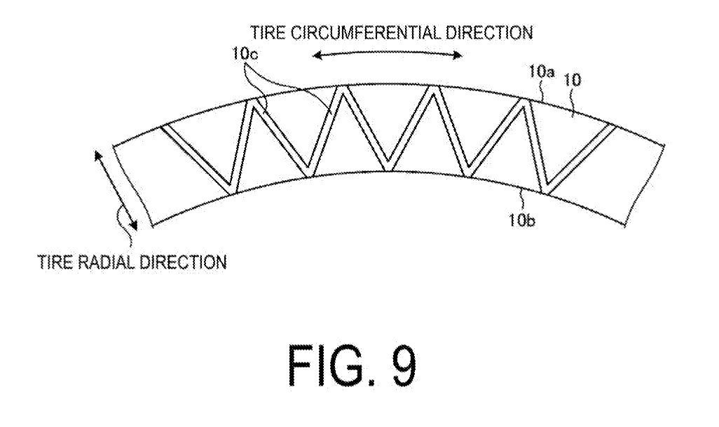

The projection portion 10 illustrated in FIG. 5 includes a plurality of circular recesses/protrusions (protrusion portions and recessed portions) 10c formed on the inner surface in the tire lateral direction. The projection portion 10 illustrated in FIG. 6 includes a plurality of band-like recesses/protrusions (protrusion portions and recessed portions) 10c aligned in the tire radial direction extending in the tire circumferential direction formed on the inner surface in the tire lateral direction. The projection portion 10 illustrated in FIG. 7 includes a plurality of band-like recesses/protrusions (protrusion portions and recessed portions) 10c aligned in the tire circumferential direction extending in the tire radial direction formed on the inner surface in the tire lateral direction. The projection portion 10 illustrated in FIG. 8 includes a plurality of band-like recesses/protrusions (protrusion portions and recessed portions) 10c aligned in the tire circumferential direction and curved in the tire radial direction formed on the inner surface in the tire lateral direction. The projection portion 10 illustrated in FIG. 9 includes a plurality of band-like recesses/protrusions (protrusion portions and recessed portions) 10c inclined in the tire radial direction formed on the inner surface in the tire lateral direction, adjacent recesses and protrusions joined at the end 10a side and the base end 10b side of the projection portion 10. Note that the shape of the recesses/protrusions 10c is not limited to the shapes described above, and may be only protrusion portions, only recessed portions, or a combination of protrusion portions and recessed portions.

According to the pneumatic tire 1, by the recess/protrusion 10c being formed on the inner surface of the projection portion 10 in the tire lateral direction, the surface area of the inner surface of the projection portion 10 in the tire lateral direction is increased. This increases the surface area for shielding the air column resonance and allows the noise shielding effect to be significantly obtained.

As illustrated in FIGS. 1 and 2, in the pneumatic tire 1 of the present embodiment, in a meridian cross-section, a distance D in the tire radial direction between the road contact surface S of the tread portion 2 and the end 10a of the projection portion 10 is preferably 0.5 mm or greater when the tire is mounted on a regular rim, inflated to the regular internal pressure, and loaded with 70% of the regular load.

For the distance D in the tire radial direction between the road contact surface S of the tread portion 2 and the end 10a being less than 0.5 mm, when the pneumatic tire 1 deforms when the vehicle travels, the frequency of the projection portion 10 coming into contact with the road surface and the like is likely to increase, increasing instances of the projection portion 10 deforming. Accordingly, by the distance D in the tire radial direction between the road contact surface S of the tread portion 2 and the end 10a being 0.5 mm to greater, the instances of the projection portion 10 deforming are reduced. This allows a vehicle exterior noise reduction effect to be ensured.

As illustrated in FIGS. 3 and 4, in the pneumatic tire 1 of the present embodiment, the projection portion 10 has an angle θ formed by a center straight line SL and a tire radial direction line L in a meridian cross-section preferably ranging from 15° inward in the tire lateral direction to 45° outward in the tire lateral direction when the tire is mounted on a regular rim, inflated to the regular internal pressure, and loaded with 70% of the regular load.

The angle θ ranges from −15° to +45°, where the angle θ of the tire radial direction line L is taken as 0° and tilt inward in the tire lateral direction is taken as minus and tilt outward in the tire lateral direction is taken as plus.

When the angle θ formed by the center straight line SL and the tire radial direction line L is less than −15° (larger minus angle), the projection portion 10 is susceptible to coming into contact with the tire itself, which may cause wear and chipping in the portion where contact occurs. When the angle θ formed by the center straight line SL and the tire radial direction line L is greater than +45° (larger plus angle), the projection portion 10 is disposed away from the lug groove 24, making a noise shielding effect difficult to obtain. Accordingly, by the angle θ formed by the center straight line SL and the tire radial direction line L ranging from −15° to +45°, a noise shielding effect from the projection portion 10 can be significantly obtained. Note that to more significantly obtain a noise shielding effect from the projection portion 10, the angle θ formed by the center straight line SL and the tire radial direction line L preferably ranges from −5° to +30°.

Furthermore, the pneumatic tire 1 of the present embodiment preferably has a designated vehicle inner/outer orientation when mounted on a vehicle, and the projection portion 10 is preferably formed at least on the vehicle outer side.

The designated vehicle inner/outer side orientation when the tire is mounted on a vehicle, while not illustrated in the drawings, for example, can be shown via indicators provided on the sidewall portion 4. The side facing the inner side of the vehicle when the tire is mounted on the vehicle is the “vehicle inner side”, and the side facing the outer side of the vehicle is the “vehicle outer side”. Note that the designations of the vehicle inner side and the vehicle outer side are not limited to cases where the tire is mounted on a vehicle. For example, in cases when the tire is mounted on a rim, orientation of the rim with respect to the inner side and the outer side of the vehicle in the tire lateral direction is predetermined. Thus, in cases in which the pneumatic tire 1 is mounted on a rim, the orientation with respect to the vehicle inner side and the vehicle outer side in the tire lateral direction is designated.

According to the pneumatic tire 1, vehicle external noise is released on the vehicle outer side. Thus, by forming the projection portion 10 on at least the vehicle outer side, noise shielding can be effectively provided, and vehicle external noise can be reduced.

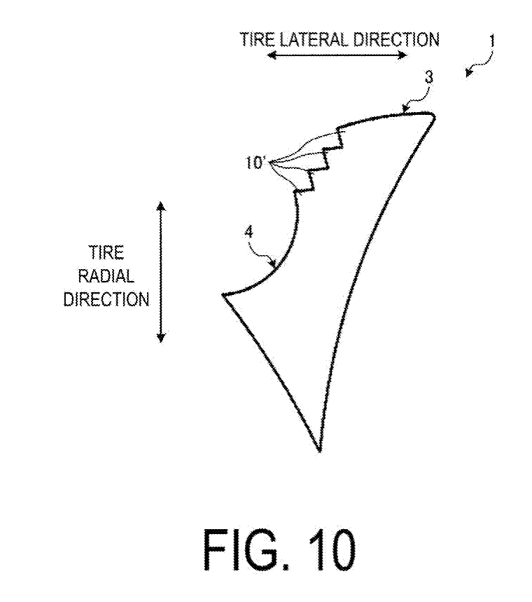

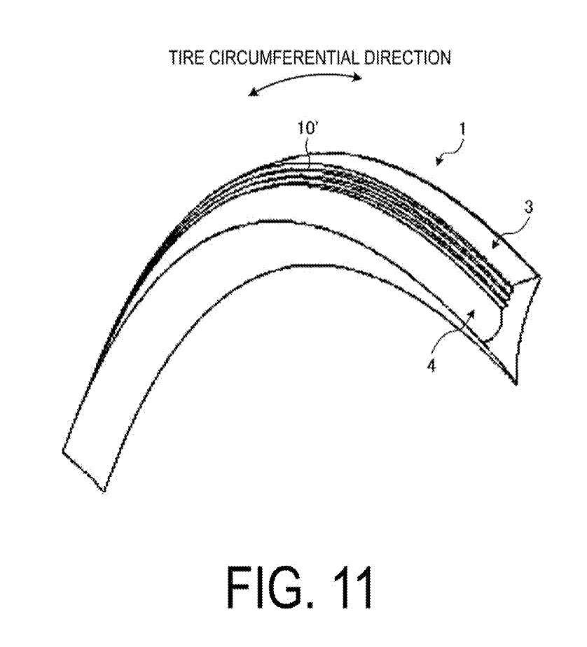

FIG. 10 is an enlarged cross-sectional view of a main portion of another example of the pneumatic tire according to the present embodiment. FIG. 11 is a partial perspective view of the example of the pneumatic tire illustrated in FIG. 10.

As illustrated in FIGS. 10 and 11, another example of the pneumatic tire 1 according to the present embodiment includes a projection portion 10′ instead of the projection portion 10 described above. The projection portion 10′ is provided continuously in the tire circumferential direction and is disposed outward in the tire lateral direction of the opening portion of the outermost lug groove 24 in the tire lateral direction provided on the tread portion 2. The projection portion 10′ is formed projecting outward in the tire radial direction. Additionally, a plurality (four in the present embodiment) of the projection portions 10′ are formed in the tire radial direction. In FIGS. 10 and 11, the projection portions 10′ have a triangular shape in a meridian cross-section with a V-shaped groove provided therebetween.

### EXAMPLES

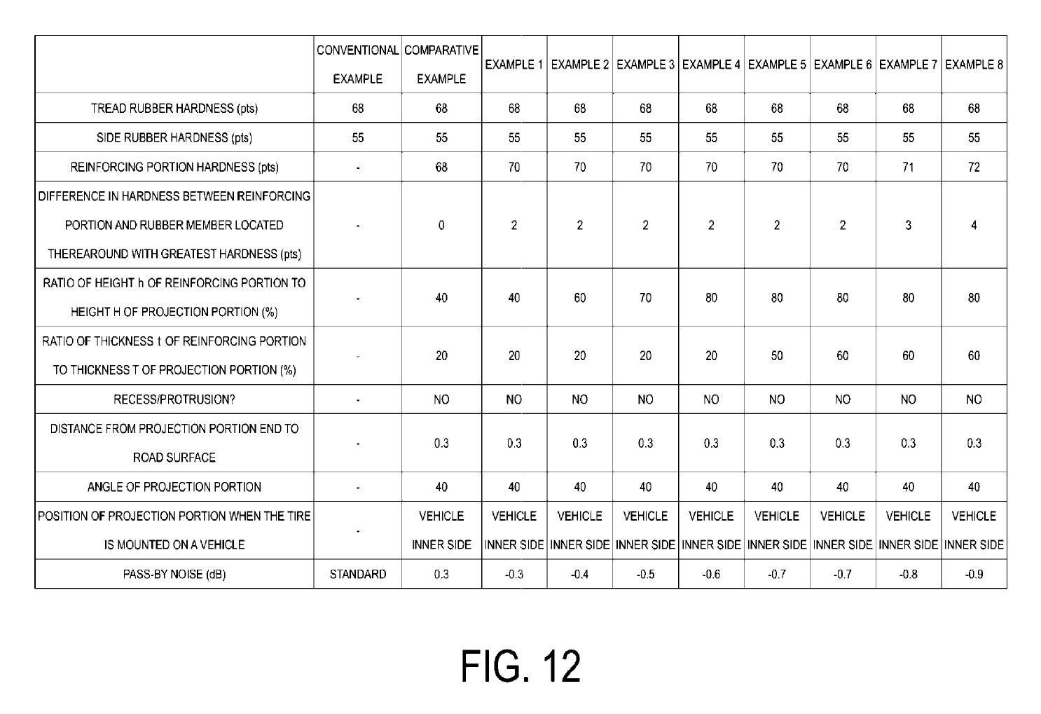

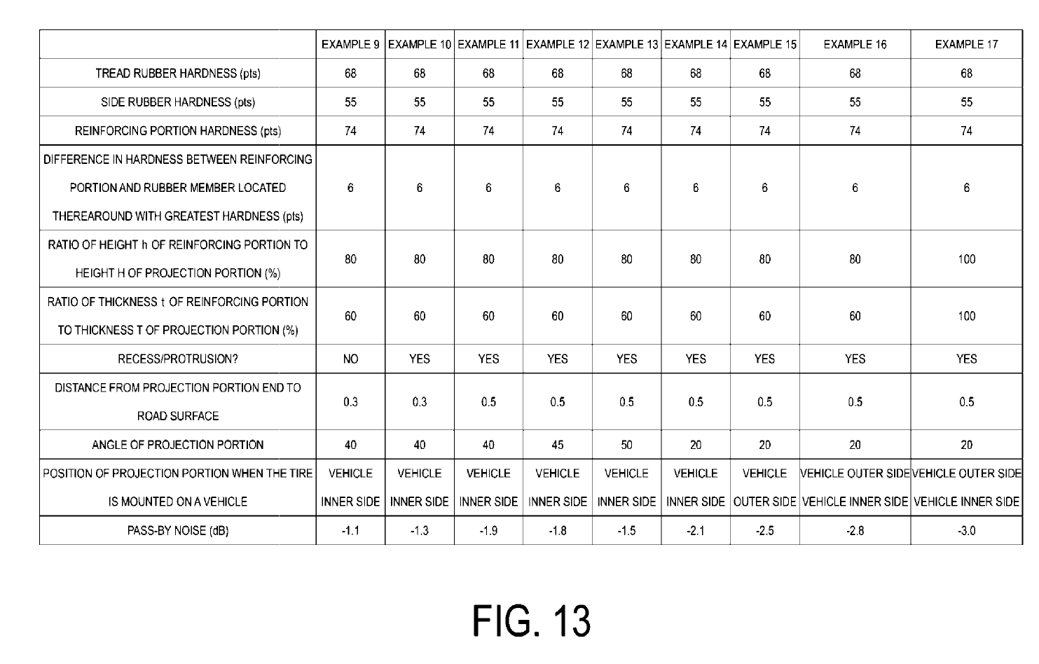

In the examples, performance tests for pass-by noise were performed on a plurality of types of pneumatic tires of different conditions (see FIGS. 12 and 13).

In the performance tests, pneumatic tires (test tires) having a tire size of 245/40R18 93W were mounted on regular rims and inflated to the regular internal pressure (250 kPa). Then, the pneumatic tires were mounted on a sedan type test vehicle having an engine displacement of 3000 cc.

In the evaluation method of pass-by noise, the magnitude of vehicle external pass-by noise was measured according to the tire noise test method specified in ECE (Economic Commission for Europe) Regulation No. 117 Revision 2 (ECE R117-02). In the test, the test vehicle was driven in a section prior to a noise measurement section, and before the noise measurement section the engine was stopped and the test vehicle was allowed to coast in the noise measurement section where the maximum noise level dB (noise level in the frequency range of 800 Hz to 1200 Hz) was measured. This was repeated a plurality of times at a plurality of speeds, the speeds being eight or more substantially evenly divided within the range of ±10 km/h of the standard speed, and the average vehicle external pass-by noise was taken. The maximum noise level dB is the sound pressure dB (A) measured through an A characteristic frequency correction circuit using a microphone installed 7.5 m to the side of a travel center line and 1.2 m up from the road surface at a middle point in the noise measurement section. The measurement results are expressed as index values and evaluated with the conventional example being assigned as the reference (0). In the evaluation, values for the sound pressure dB less than the reference indicate low pass-by noise and superior vehicle external noise reduction performance.

The pneumatic tire of the conventional example illustrated in FIG. 12 includes no projection portions. The pneumatic tire of the comparative example includes a projection portion with the shape illustrated in FIG. 3 but no reinforcing portion. As indicated in FIGS. 12 and 13, the pneumatic tires of Examples 1 to 17 are provided with a projection portion with the shape illustrated in FIG. 3 and a reinforcing portion. Note that the angle of the projection portion is minus when tilted inward in the tire lateral direction and plus when tilted outward in the tire lateral direction.

As can be seen from the test results of FIGS. 12 and 13, the pneumatic tires of Examples 1 to 17 have low pass-by noise and enhanced vehicle external noise reduction performance.

1. A pneumatic tire, comprising:
a lug groove disposed outermost in a tire lateral direction in a tread portion, the lug groove opening outward in the tire lateral direction;
a projection portion disposed outward of an opening portion of the lug groove in the tire lateral direction, the projection portion extending outward in a tire radial direction past a groove bottom of the lug groove at maximum groove depth in a meridian cross-section and comprising an end disposed inward of a road contact surface of the tread portion in the tire radial direction, when the pneumatic tire is mounted on a regular rim, inflated to a regular internal pressure, and loaded with 70% of a regular load; and
a reinforcing portion disposed at least at a base end of the projection portion, the reinforcing portion having a JIS-A rubber hardness greater than a JIS-A rubber hardness of a rubber material around the projection portion.

2. The pneumatic tire according to claim 1, wherein the reinforcing portion has a height h ranging from 60% to 100% of an extension height H of the projection portion in a meridian cross-section.

3. The pneumatic tire according to claim 1, wherein the reinforcing portion has a thickness t ranging from 50% to 100% of a thickness T of the projection portion in a meridian cross-section.

4. The pneumatic tire according to claim 1, wherein the reinforcing portion has a JIS-A rubber hardness of 3 points or greater than a JIS-A rubber hardness of a rubber material around the projection portion with a greatest JIS-A rubber hardness.

5. The pneumatic tire according to claim 1, wherein a recess/protrusion is formed on an inner surface of the protrusion portion in the tire lateral direction.

6. The pneumatic tire according to claim 1, wherein the projection portion has a distance in the tire radial direction from the road contact surface of the tread portion to the end of 0.5 mm or greater in a meridian cross-section, when the pneumatic tire is mounted on a regular rim, inflated to a regular internal pressure, and loaded with 70% of a regular load.

7. The pneumatic tire according to claim 1, wherein the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

8. The pneumatic tire according to claim 1, wherein a vehicle inner/outer side orientation when the pneumatic tire is mounted on a vehicle is designated, and the projection portion is at least formed on a vehicle outer side.

9. The pneumatic tire according to claim 2, wherein the reinforcing portion has a thickness t ranging from 50% to 100% of a thickness T of the projection portion in a meridian cross-section.

10. The pneumatic tire according to claim 9, wherein the reinforcing portion has a JIS-A rubber hardness of 3 points or greater than a JIS-A rubber hardness of a rubber material around the projection portion with a greatest JIS -A rubber hardness.

11. The pneumatic tire according to claim 10, wherein a recess/protrusion is formed on an inner surface of the protrusion portion in the tire lateral direction.

12. The pneumatic tire according to claim 11, wherein the projection portion has a distance in the tire radial direction from the road contact surface of the tread portion to the end of 0.5 mm or greater in a meridian cross-section, when the pneumatic tire is mounted on a regular rim, inflated to a regular internal pressure, and loaded with 70% of a regular load.

13. The pneumatic tire according to claim 12, wherein the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

14. The pneumatic tire according to claim 13, wherein a vehicle inner/outer side orientation when the pneumatic tire is mounted on a vehicle is designated, and the projection portion is at least formed on a vehicle outer side.
